(19) United States
(12) Patent Application Publication
(10) Pub. No.: US 2010/0156655 A1
(43) Pub. Date: Jun. 24, 2010

(54) EQUIPMENT AREA ALARM SUMMARY DISPLAY SYSTEM AND METHOD

(75) Inventors: Peter Bullemer, Independence, MN (US); Dal Vernon Reising, Canton, MI (US); Mischa Tolsma, Secunda (ZA)

Correspondence Address: HONEYWELL/ORTIZ & LOPEZ;PATENT SERVICES, 101 Columbia Road, Morristown, NJ, 07962-2245, US

(73) Assignee: Honeywell International Inc.

(21) Appl. No.: 12/339,995

(22) Filed: Dec. 19, 2008

(51) Int. Cl. G08B 5/00; G06F 3/033; G09G 5/00

(52) U.S. Cl. 340/691.6; 345/163; 345/581

(57) ABSTRACT

An equipment area alarm summary display system and method that can help operators cope with inevitable alarm floods is disclosed. An equipment area summary display with dedicated screen areas for each major equipment area works together with a detailed list display. Alarms within each equipment area can be grouped logically and can be shown via an icon with the most recent alarm indicators showing at the top of the display for each area. A specific alarm indication in the equipment area summary display can be selected so that a corresponding item can be highlighted in the detailed list display, if the alarms are active. Thus enabling the operator to minimize the time needed to develop awareness of the flood situation and intervene to get the process back under control.

### TECHNICAL FIELD

Embodiments are generally related to data-processing systems and methods. Embodiments also relate in general to the field of computers and similar technologies, and in particular to software utilized in this field. In addition, embodiments relate to equipment area alarm summary display systems and methods.

### BACKGROUND OF THE INVENTION

Process control alarm systems are utilized in the area of factory automation and/or plants. A process control alarm system is employed in a distributed control system (DCS) of the factories and/or plants. Within the plants, various manufacturing processes include machines and equipment, which can be constantly monitored by a number of process control alarms. Specifically, these process control alarms inform operators that a process has exceeded process control tolerance limits.

Today, a software interface, especially GUI (Graphical User Interface), is utilized to aid the operators in understanding the overall process control alarms and its variables of one or more machines. These process control alarm variables are set and monitored through the GUI interface. In such alarm systems, the operators receive a large number of alarms at less period of time, which is named as alarm floods. The alarm floods are the phenomenon of presenting more alarms in a given period of time than a human operator can effectively respond to. Such alarm floods are inherently inadequate to support an operator in recognizing and coping with resulting abnormal or crisis situations.

In one prior art approach, the alarm systems create an alarm summary display to improve alarm system performance through improved alarm rationalization and alarm system maintenance practices. These efforts can make a considerable impact on reducing the likelihood of alarm flooding in the operator console through better alarm configuration and effective use of suppression techniques. However, even the alarm summary display does not eliminate the occurrence of alarm flooding to help the operator.

The majority of prior art alarm systems describe the visualization or design of a traditional alarm summary list of alarms in the DCS systems to the operator. These alarms summary lists pertain to how to configure or manage the alarms, but they do not aid the operator to easily handle the alarm floods in the DCS systems. Such an alarm system is not sufficient to reduce the alarm loads to a level that human operators can mentally process and physically respond to. Therefore, it is desirable to provide effective display design techniques to help operators cope with these inevitable alarm floods.

In an effort to address the foregoing difficulties, it is believed that a need exists for an improved equipment area alarm summary display system and method, which assists human operator coping with alarm floods. It is believed that the improved system and method disclosed herein can address these and other continuing needs.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium related to alarm management.

It is another aspect of the present invention to provide for an improved equipment area alarm summary display system and method.

It is a further aspect of the present invention to provide for an equipment area alarm summary display utilized in the context of distributed control system (DCS) system.

The aforementioned aspects and other objectives and advantages can now be achieved as described herein. An equipment area alarm summary display system and method that can help operators cope with inevitable alarm floods is disclosed. An equipment area summary display with dedicated screen areas for each major equipment area works together with a detailed list display. Alarms within each equipment area can be grouped logically and can be shown via an icon with the most recent alarm indicators showing at the top of the display for each area. A specific alarm indication in the equipment area summary display can be selected so that a corresponding item can be highlighted in the detailed list display, if the alarms are active, thus enabling the operator to minimize the time needed to develop awareness of the flood situation and intervene to get the process back under control.

The dedicated screen area for each major equipment area can be either a full and/or a half panel screen area for up to 16 areas total, which can be sufficient for an operator's span of control. The alarm description in the equipment area summary represents the parameter type such as temperature, pressure, level, flow, point ID, and alarm type. Moreover, the equipment area summary display can include gray bands, color choices and font style/size for each selected equipment area, which improves segregation of locations.

A tool tip field can display a complete alarm description including a complete tag name, when a mouse is pointed over the alarm indicators in the equipment area summary display. The tag name can be shown for the alarms in a real-time presentation area. An acknowledge action button on the bottom of the detailed list display allows an operator to acknowledge any alarms selected in the detailed list display. Unacknowledged alarms can be shown via a fuller saturation and acknowledged alarms can be shown via a reduced saturation. The equipment area alarm summary display system works in conjunction with the detailed list display with highlighting and filtering functions in order to help the operator focus.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention can be embodied;

FIG. 2 illustrates a schematic view of a software system including an operating system, application software, and a user interface for carrying out the present invention;

FIG. 3 depicts a graphical representation of a network of data processing systems in which aspects of the present invention can be implemented;

FIG. 4 illustrates a schematic overview of a computer network environment in which the present invention can be deployed;

FIG. 5 illustrates a screen display of an application window of an equipment area alarm summary display application, in accordance with a preferred embodiment;

FIG. 6 illustrates a screen display of an interface for the alarm application, in accordance with a preferred embodiment; and

FIG. 7 illustrates a flow chart of equipment area alarm summary display method utilizing the equipment area alarm summary display application, in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

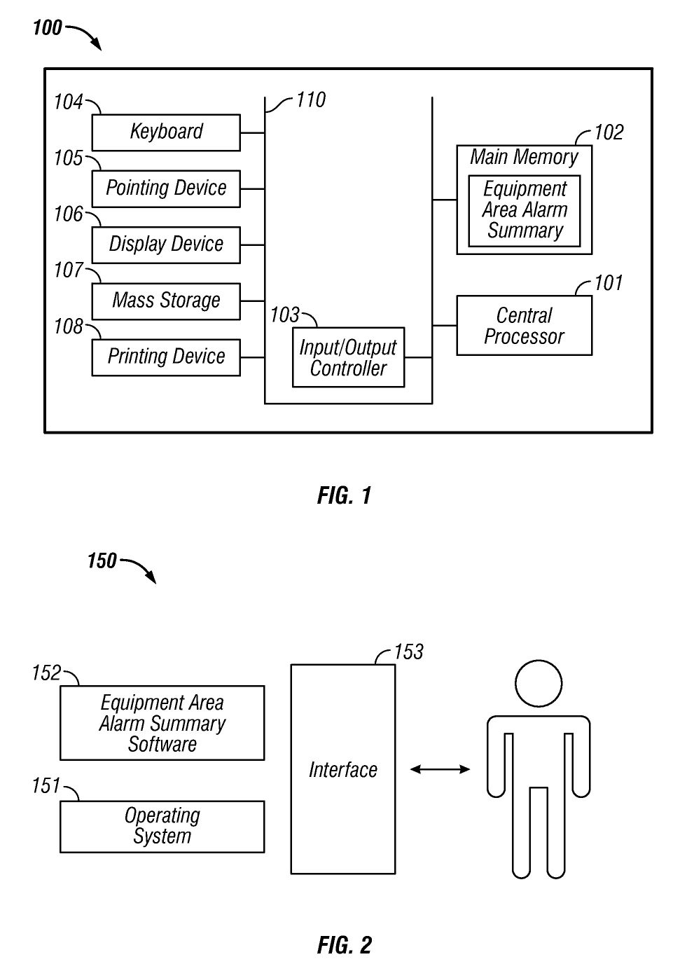

FIGS. 1-3 are provided as exemplary diagrams of data processing environments in which embodiments of the present invention can be implemented. It should be appreciated that FIGS. 1-3 are only exemplary and are not intended to assert or imply any limitation with regard to the environments in which aspects or embodiments of the present invention can be implemented. Many modifications to the depicted environments can be made without departing from the spirit and scope of the present invention.

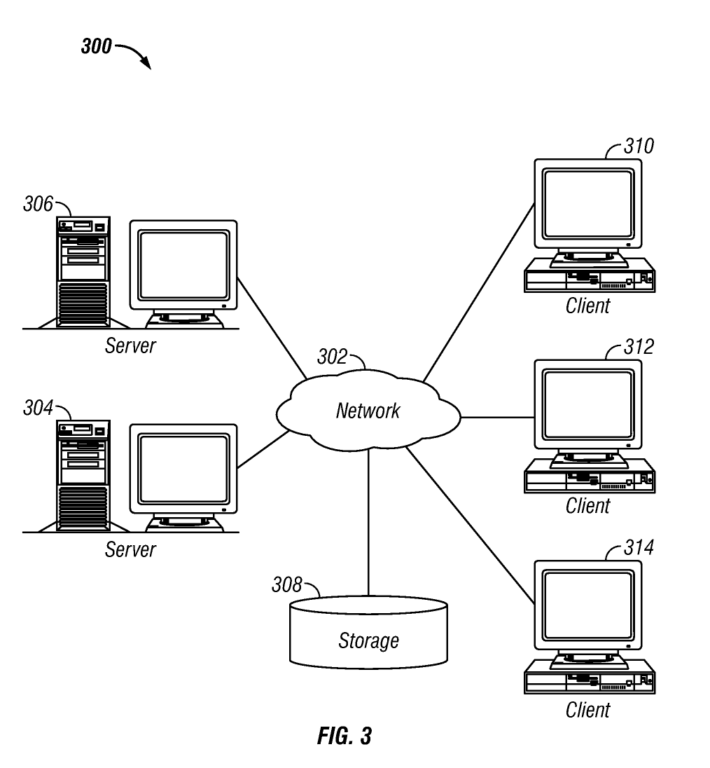

As depicted in FIG. 1, the present invention can be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, can be included in the data-processing apparatus 100 as desired. As illustrated, the various components of the data-processing apparatus 100 communicate through a system bus 110 or similar architecture. Equipment area alarm summary programming software 111 can be stored in the main memory 102 and executed by the central processor 101. Data-processing apparatus 100 can include a server or a group of interconnected servers, depending upon design considerations. For example, data-processing apparatus 100 can include servers, such as, for example, servers 304 and 306 depicted in FIG. 3.

Illustrated in FIG. 2, a computer software system 150 is provided for directing the operation of the data-processing apparatus 100. Software system 150, which is stored in system memory 102 and on disk memory 107, includes a kernel or operating system 151 and a shell or interface 153. One or more application programs, such as equipment area alarm summary application software 152, may be “loaded” (i.e., transferred from storage 107 into memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 152.

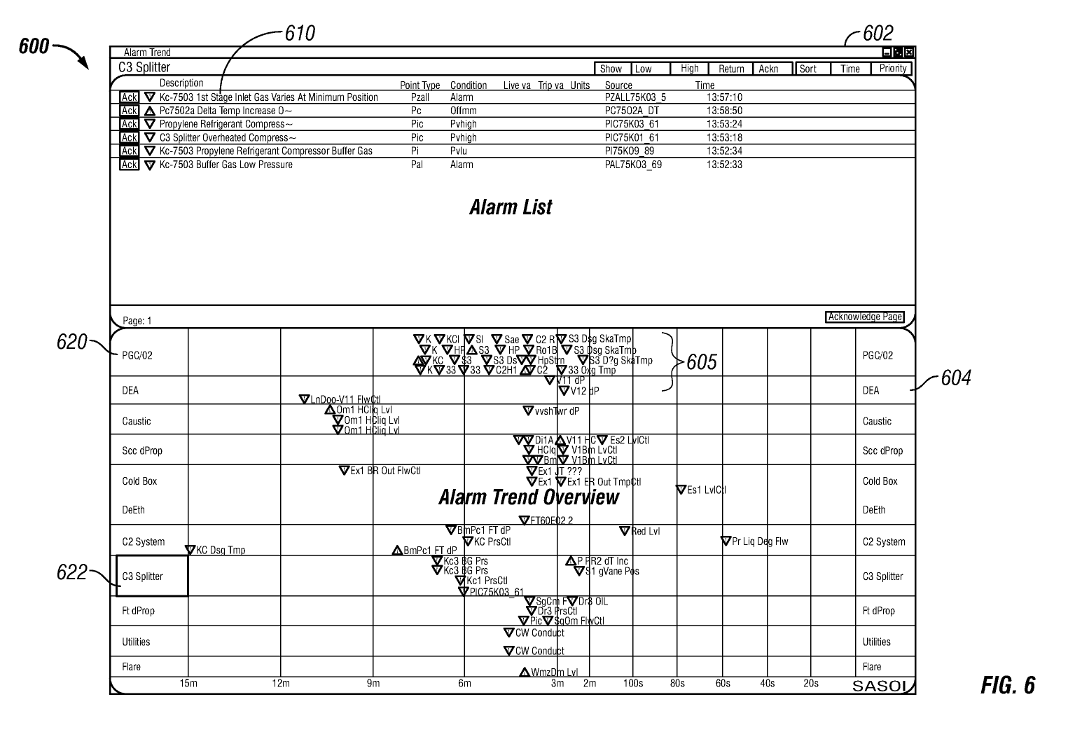

The interface 153, which is preferably implemented as a graphical user interface (GUI), also serves to display results, whereupon the user may supply additional inputs or terminate the session. In some embodiments, operating system 151 and interface 153 can be implemented in the context of a Windows®-based system or another appropriate computer operating system. Window® is a registered trademark of Microsoft Corporation. Equipment area alarm summary application module 152, on the other hand, can include instructions, such as the various operations described herein with respect to the various components and modules described herein, such as, for example, the method 600 depicted in FIG. 6.

FIG. 3 depicts a graphical representation of a network of data processing systems in which aspects of the present invention may be implemented. Note that the system 300 can be implemented in the context of a software module such as application software 152 with equipment area alarm summary programming. Network data processing system 300 is a network of computers in which embodiments of the present invention may be implemented. Network data processing system 300 contains network 302, which is the medium used to provide communications links between various devices and computers connected together within network data processing apparatus 100. Network 102 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing apparatus 100 depicted in FIG. 1 can be, for example, a client such as client 310, 312, and/or 314. Alternatively, data-processing apparatus 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 can include additional servers, clients, and other devices not shown. Specifically, clients may connect to any member of a network of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example, and not as an architectural limitation for different embodiments of the present invention.

The following description is presented with respect to embodiments of the present invention, which can be embodied in the context of a data-processing system such as data-processing apparatus 100, computer software system 150 and data processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

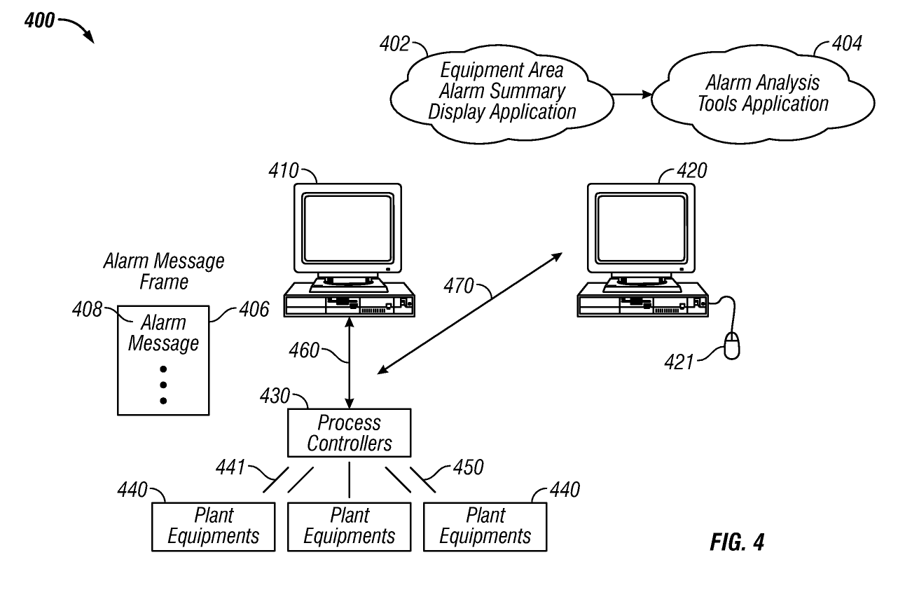

FIG. 4 illustrates a schematic overview of a computer network environment 400 in which the present invention is deployed. The computer network environment 400 can briefly comprise an alarm system host computer 410 and an alarm auxilliary computer 420 with an equipment area alarm summary display application 402. The alarm system host computer 410 can communicate to a set of process controllers 430 via an alarm system host computer data communication link 460. The alarm analysis tools auxiliary computer 420 can tap into the alarm system host computer data communication link 460 via an alarm analysis tools auxiliary computer data communication link 470. In the preferred embodiment of the present invention, the alarm analysis tools auxiliary computer 420 can include I/O (input/output) accessories, such as a computer mouse 421. Other cursor control devices and input means (e.g. keyboards and the like) are also suitable to the alarm analysis tools auxiliary computer 420.

The alarm system host computer 410 can receive an alarm message frame 406, which is issued by the process controllers 430 to the alarm system host computer 410 via the alarm system host computer data communication link 460. The alarm analysis tools auxiliary computer 420 can simultaneously receive the alarm message frame 406 via the alarm analysis tools auxiliary computer data communication link 470. The received alarm message frame 406 can be processed by an alarm analysis tools application 404, which resides on the alarm analysis tools auxiliary computer 420. The alarm analysis tools application 404 can be pre-configured and display a set of alarm messages 408 in accordance with information provided by the equipment area alarm summary display application 402.

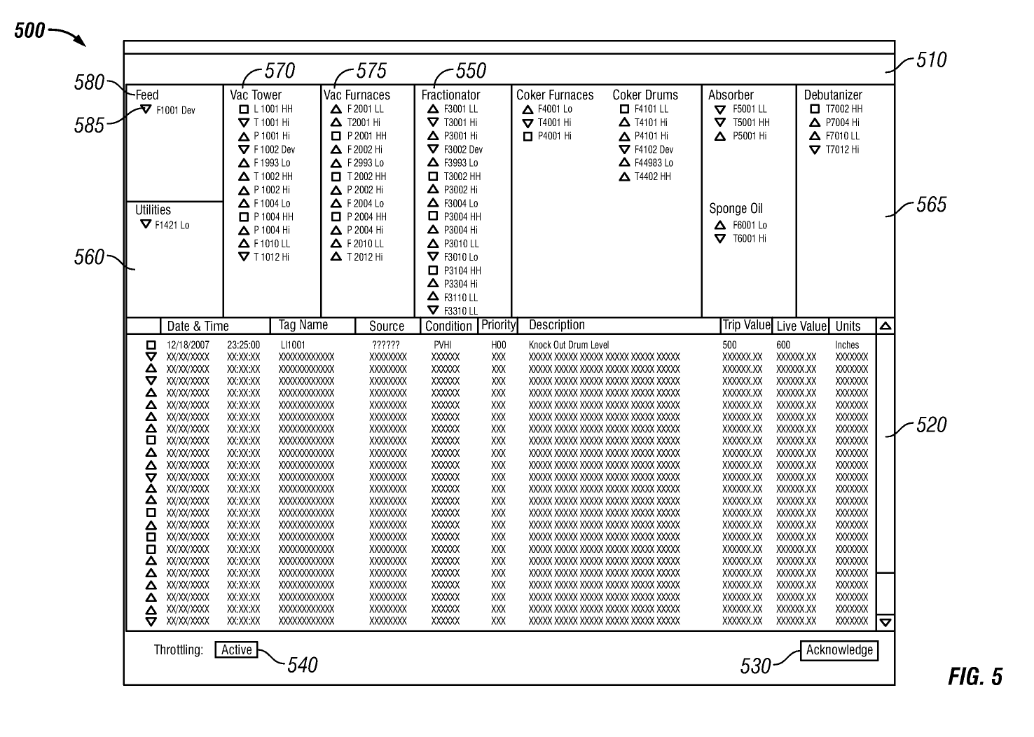

The alarm message frame 406 can be generated by the process controllers 430 in response to alarm signals 441 received from a set of plant equipments 440 via process controller links 450. The alarm signals 441 can be issued from the plant equipments 440 due to an out-of-range detection, failure detection or a malfunction of the plant equipments 440. The alarm messages 408 can be transferred in the alarm message frame 406 in response to the process controllers 430. Such alarm messages 408 can be determined, organized and categorized into an equipment area summary display 510 and an alarm summary display 520, as illustrated in FIG. 5, by the equipment area alarm summary display application 402.

FIG. 5 illustrates a screen display of an application window 500 of an equipment area alarm summary display application 402, in accordance with a preferred embodiment. Application window 500 can be implemented utilizing a GUI as described above and provided by a software module such as, for example, module 152 illustrated in FIG. 3. The application window 500 of the equipment area alarm summary display application 402 can include an equipment area summary display 510 that works in conjunction with a detailed list display 520 in the distributed control system (DCS) system 400 with highlighting and filtering functions to help the operator focus. Note that in FIGS. 1-6 identical parts or elements are generally indicated by identical reference numerals. The equipment area summary display 510 comprises dedicated screen areas for each major equipment area 550 that works together with the detailed list display 520 for all selected major equipment areas 570 and 575.

The equipment area summary display 510 includes an alarm summary associated with each major equipment area 550 associated with an operator's scope of responsibility. The detailed list display 520 shows the detailed alarm descriptions for all selected major equipment areas 570 in the equipment area summary display 510. The equipment area 550 can be either displayed as a full panel 565 and/or as a half panel 560 for up to 16 areas depending upon an operator's span of control. If there are more than 16 equipment areas, then less “critical” areas can be combined. The alarms 580 within each equipment area 550 can be grouped logically and are shown via an icon 585 with the most recent alarm indicators showing at the top of the display 510 for each area. A specific alarm indication in the equipment area summary display 510 can be selected so that a corresponding item can be highlighted in the detailed alarm summary list 520, if the alarms are active.

The alarm descriptions in the equipment area summary display 510 represents the parameter type (T=Temperature; P=Pressure; L=level; F=Flow), point ID (as an abbreviated tag ID), and alarm type (Dev, LL, Lo, Hi, HH). Moreover, the equipment area summary display 510 can include gray bands, color choices and font style/size for each selected equipment area, which improves segregation of locations. For example, there are two areas selected as shown in darker gray panel and bolded text on area label i.e., Vac Tower 570 and Vac Furnaces 575, as illustrated in FIG. 5. The equipment areas 550 may be selected and/or unselected by clicking on the label for that equipment area 550.

A tool tip field (not shown) can display a complete alarm description including a complete tag name, when a mouse such as a mouse 421 as shown in FIG. 4, is pointed over the alarm indicators 580 in the equipment area summary display 510. The tag name can be shown for the alarms in a real-time presentation area. An acknowledge action button 530 appears on the bottom of the detailed alarm summary display 520 to allow an operator to acknowledge any alarms selected in the detailed list view 520. For example, unacknowledged alarms are shown via fuller saturation and acknowledged alarms are shown via a reduced saturation. If there are more than 16 alarms associated with an equipment area, the 16 most recent alarms are shown only with the exception that unacknowledged alarms are displayed in preference to acknowledged alarms. Such an application window 500 of the equipment area alarm summary display application 402 enables the operator to minimize the time needed to develop awareness of the flood situation. A throttling button 540 appears on the bottom of the detailed list display 520 allows an operator to activate throttling. The display refresh rate will be once every 30 seconds if throttling is active.

Referring to FIG. 6, an screen shot 600 of an alternate presentation of the equipment area alarm display is illustrated. The alternative display 600 can provide an overview of alarms by equipment area by showing the time-based order of the alarms. The Alarm Trend display 600 as shown includes s two main portions: the Alarm Trend Overview 602 and the Alarm List 604. The alarm trend overview 602 contains an alarm timeline for each major equipment area, e.g., C3 Splitter 622. Each alarm is represented by an icon that indicates alarm priority—e.g., emergency, high, or low priority—as well as alarm type—e.g., Low Limit, High Limit, BadPV, and so on. In addition, each alarm can be represented by a short descriptor. With a mouse-over, an operator can obtain details of an alarm as well as long descriptions. Furthermore, several rows of descriptors can be shown for a relevant price of equipment. For example, the PGC/O2 equipment has four rows 605 listed. The alarm list pane 604 can be provided in the form of a traditional alarm list 610 as shown, but can be re-organized for easier reading, where the newest alarm is listed at the top, by default, and alarms move down in the list as other newer alarms enter.

By observing the display, an operator can easily find the most critical process conditions in the Equipment Rows in the Alarm Trend window. Use the icons, which indicate: alarm priority—either low, high, or urgent priority; the type of alarm—like a Lo-Lo limit exceedance, Hi-Hi exceedance, BadPV, etc.; the alarm status—whether it is Active, Unacknowledged (full color & flashing), Active, Acknowledged (half-color & not flashing), or Active, Return-to-Normal (white color and flashing). An operator can identify the most critical alarm condition by looking at one or more of the following: the highest priority, unacknowledged alarm (still flashing); the equipment area with the most unacknowledged alarms; and the most critical equipment area with an unacknowledged alarm. Short descriptors should also help you identify the most critical alarm(s).

After identifying the most critical alarm condition, an operator can look at the alarm or pattern of alarms for that equipment area to determine what actions should be taken by observing the pattern of alarms, by looking at the Alarm Trend window and the icons and short descriptors associated with the critical alarm condition. If more information is needed than the icons and short descriptors, an operator can mouse-over on the critical alarm or group of alarms get a pop-up menu that has long descriptions that are normally obtainable in the alarm list. When there is a group or burst of alarms, an operator should normally not respond to single alarms, but instead can look for the pattern of alarms if there is more than one alarm and respond to the underlying process condition generating the group of alarms. Alternatively, an operator can focus the alarm list on the equipment area that has the critical alarm condition, by clicking in that equipment area in the Alarm Trend window. While taking the control actions, an operator can keep monitoring the summary information to make sure other more critical alarms have not come in for another equipment area. If a more critical alarm condition arises in another equipment area, an operator can repeat the alarm response strategy for that more critical alarm condition. After completing the required control actions, acknowledge the alarm or alarms that an operator just dealt with. It is important to acknowledge alarms after an operator have taken the appropriate control actions, so that you can keep up with alarms more easily during alarm flood situations. To acknowledge a group of alarms for that equipment area, an operator can do a mouse-over and right-click, which gives you the “Acknowledge Cluster” button in the pop-up text box. By clicking the “Acknowledge Cluster” button in the pop-up text box the system can acknowledge all the alarms in the pop-up box. If that equipment area is in the Alarm List, an operator can click on the “Acknowledge Page” button below the Alarm List. To acknowledge one alarm, an operator can focus the alarm list on a specific Equipment Area by clicking in that equipment area in the Alarm Trend view, then click the “Ack” button in the row of the one alarm that you want to acknowledge. After acknowledging the alarm or alarms in the alarm condition that an operator had taken appropriate control actions for, an operator can return to the summary information in the new summary displays, and repeat the overall alarm response strategy.

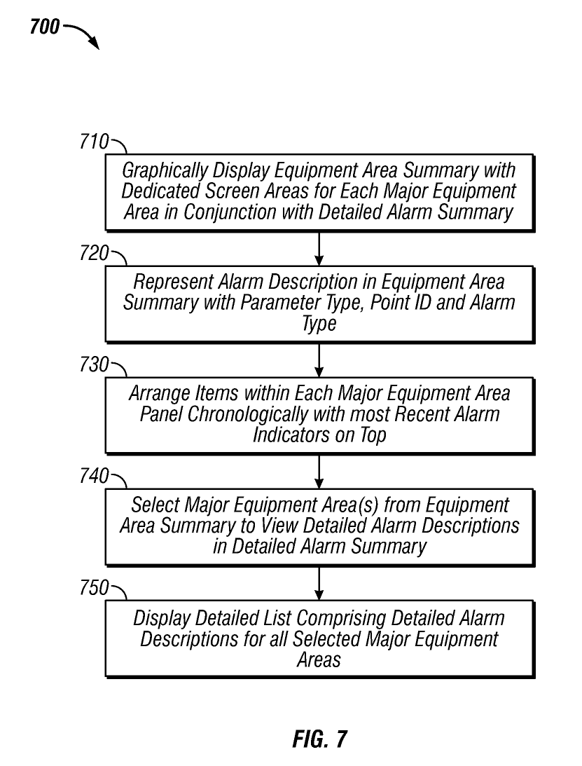

FIG. 7 illustrates a flow chart of operations depicting an equipment area alarm summary display method 600, in accordance with a preferred embodiment. Note that the method 600 can be implemented in the context of a computer-useable medium that contains a program product. The method 600 depicted in FIG. 7 can also be implemented in a computer-usable medium containing a program product.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 700 described herein can be deployed as process software in the context of a computer system or data-processing system as that depicted in FIGS. 1-3.

An equipment area summary display 510 with dedicated screen areas for each major equipment area 550 can be graphically displayed in conjunction with a detailed list display 520, as depicted at block 710. The alarm description in the equipment area summary 510 can be represented with parameter type, point ID and alarm type, as depicted at block 720. Thereafter, items and/or alarms within each major equipment area panel 550 can be arranged chronologically with most recent alarm indicators 580 on top, as depicted at block 730. Next, as depicted at block 740, the major equipment area(s) 550 can be selected from the equipment area summary display 510 to view detailed alarm descriptions in the detailed list display 520. The detailed alarm summary display 520 comprising detailed alarm descriptions for all selected major equipment areas 570 and 575 can be displayed, as depicted at block 750. Hence, the method 700 can allow an operator to see when alarms occur, their sequence, relations and priority, which aid the operators cope with inevitable alarm floods.

The two displays 510 and 520 work together wherein the display 510 provides high level alarm information grouped logically into major equipment areas. The display 520 provides detailed information on an alarm. Such display design techniques help operators cope with these inevitable alarm floods. Specifically, the displays 510 and 520 help an operator understand how a flood developed and could minimize the time needed to develop awareness of the flood situation and intervene to get the process back under control.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing an equipment area alarm summary display, comprising:
graphically displaying an equipment area summary display associated with at least one dedicated screen area for at least one major equipment area in conjunction with a detailed list display;
grouping at least one alarm associated with said at least one major equipment area logically and showing a most recent alarm indicators at top of said at least one major equipment area wherein said at least one alarm are displayed via an icon; and
selecting at least one alarm in said at least one major equipment area so that a corresponding alarm description item is highlighted and displayed in said detailed list display, if said alarm is active, thereby allowing an operator to see when said alarm occur, their sequence, relation and priority, which helps said operator cope with an inevitable alarm flood.

2. The method of claim 1 further comprising:
displaying a complete alarm description with a tag name in a tool tip field in said equipment area summary display, when a mouse is pointed over said at least one alarm in said at least one major equipment area.

3. The method of claim 1 further comprising:
acknowledging said at least one alarm selected in said detailed list display through an acknowledge action button on bottom of said detailed list display.

4. The method of claim 1 wherein said at least one major equipment area comprises a gray band, a color choice and a font style/size for each selected equipment area, in order to improve segregation of locations.

5. The method of claim 1 further comprising:
Incorporating a throttling button on the bottom of said detailed list display to allow an operator to activate throttling.

6. The method of claim 1 wherein said at least one dedicated screen area for said at least one major equipment area can be either a full and/or a half panel depending upon operator's span of control.

7. The method of claim 1 wherein said alarm description in said at least one major equipment area comprises parameter type, level, flow, point ID, and alarm type.

8. A method for providing an equipment area alarm summary display, comprising:
graphically displaying an equipment area summary display associated with at least one dedicated screen area for at least one major equipment area in conjunction with a detailed list display;
grouping at least one alarm associated with said at least one major equipment area logically and showing a most recent alarm indicators at top of said at least one major equipment area wherein said at least one alarm are displayed via an icon;
displaying a complete alarm description with a tag name in a tool tip field in said equipment area summary display, when a mouse is pointed over said at least one alarm in said at least one major equipment area; and
selecting at least one alarm in said at least one major equipment area so that a corresponding alarm description item is highlighted and displayed in said detailed list display, if said alarm is active, thereby allowing an operator to see when said alarm occur, their sequence, relation and priority, which helps said operator cope with an inevitable alarm flood.

9. The method of claim 8 further comprising:
acknowledging said at least one alarm selected in said detailed list display through an acknowledge action button on bottom of said detailed list display.

10. The method of claim 8 wherein said at least one major equipment area comprises a gray band, a color choice and a font style/size for each selected equipment area, in order to improve segregation of locations.

11. The method of claim 8 further comprising:
incorporating a throttling button on the bottom of said detailed list display to allow an operator to activate throttling.

12. The method of claim 8 wherein said at least one dedicated screen area for said at least one major equipment area can be either a full and/or a half panel depending upon operator's span of control.

13. The method of claim 8 wherein said alarm description in said at least one major equipment area comprises parameter type, level, flow, point ID, and alarm type.

14. A equipment area alarm summary display system, comprising:
a computer;
a display connected to said computer;
a software module operable by said computer for graphically displaying on said display an equipment area summary display associated with at least one dedicated screen area for at least one major equipment area in conjunction with a detailed list display and grouping at least one alarm associated with said at least one major equipment area logically and showing a most recent alarm indicators at top of said at least one major equipment area wherein said at least one alarm are displayed via an icon; and
a user interface for enabling a user to select at least one alarm in said at least one major equipment area so that a corresponding alarm description item is highlighted and displayed in said detailed list on said display, if said alarm is active, thereby allowing an operator to see when said alarm occur, their sequence, relation and priority, which helps said operator cope with an inevitable alarm flood.
